(19) United States
(12) Patent Application Publication
(10) Pub. No.: US 2019/0047575 A1
(43) Pub. Date: Feb. 14, 2019

(54) METHOD FOR DETERMINING A COEFFICIENT OF FRICTION FOR A CONTACT BETWEEN A TIRE OF A VEHICLE AND A ROADWAY, AND METHOD FOR CONTROLLING A VEHICLE FUNCTION OF A VEHICLE

(71) Applicant: Robert Bosch GmbH, Stuttgart (DE)

(72) Inventors: Christian Lellmann, Stuttgart (DE); Simon Geisler, Heilbronn (DE)

(21) Appl. No.: 16/100,390

(22) Filed: Aug. 10, 2018

(30) Foreign Application Priority Data
Aug. 11, 2017 (DE) 102017214032.1

(51) Int. Cl. B60W 40/068

(52) U.S. Cl. CPC B60W 40/068; B60W 2050/0052

(57) ABSTRACT

A method for determining a coefficient of friction for a contact between a tire of a vehicle includes processing sensor signals using a stochastic filter in order to generate processed sensor signals. The sensor signals represent status data pertaining to an environment region including the roadway, which are read in by at least one detection device, and which are able to be correlated with the coefficient of friction. The status data can be used as observed values in the stochastic filter. The method also includes ascertaining the coefficient of friction using the processed sensor signals.

### CROSS-REFERENCE TO RELATED APPLICATIONS

The present application claims priority under 35 U.S.C. § 119 to DE 10 2017 214 032.1, filed in the Federal Republic of Germany on Aug. 11, 2017, the content of which is hereby incorporated by reference herein in its entirety.

### FIELD OF THE INVENTION

The present invention relates to a device, method, and/or computer program for ascertaining the coefficient of friction of a contact between a tire of a vehicle and a roadway and/or controlling the vehicle based on the ascertained coefficient of friction.

### BACKGROUND

For vehicle movements, the coefficient of friction between the vehicle and the roadway, among other things, can be important. Measuring vehicles equipped with technology for measuring the coefficient of friction are able to be used for a direct, active friction-coefficient measurement in special situations, e.g., a determination of a coefficient of friction of an airfield.

The document DE 10 2005 060 219 A1 describes an estimation of a coefficient of friction between a roadway and a tire of a motor vehicle.

### SUMMARY

According to example embodiments of the present invention, a coefficient of friction between a roadway and a vehicle is able to be ascertained in particular by a time-sequence-based statistical approach. In this context, the coefficient of friction is able to be determined as an estimated value or a probability distribution of coefficients of friction with the aid of data from a sensor system or sensor signals. For this purpose, sensor signals pertaining to environmental conditions at a destination of the friction-coefficient determination are able to be subjected to a processing rule, in particular a stochastic processing rule. The coefficient of friction can be used to control a vehicle function of a vehicle, in particular an assistance function. More specifically, a cloud-based estimate of the coefficient of friction can be realized using typical conditions in an environment of the road section for which the coefficient of friction is determined, as well as a processing rule.

In an advantageous manner, in particular a precise and reliable assessment of a friction between a vehicle and the roadway is possible according to example embodiments. In the process, data from a plurality of sources, for example, can be used or in other words, collective knowledge is able to be exploited. For example, in particular also the effects of possible sensor errors can be reduced in this way and results of statistical analyses for the coefficient of friction determination be improved. A large user circle is furthermore able to be addressed, for example. In addition, the device expense for determining the coefficient of friction can be kept low and cost-effective, in particular when compared to dedicated sensor systems for coefficients of friction sensor systems. The determination of the coefficient of friction is optionally combinable with other connectivity functions. More specifically, the determination of the coefficient of friction is able to provide results with regard road sections also for vehicles that have not yet traveled such road sections on their own.

According to an example embodiment of the present invention, a method for determining a coefficient of friction for a contact between a tire of a vehicle and a roadway includes: processing sensor signals using a processing rule in order to generate processed sensor signals, the sensor signals representing at least status data, which pertain to an environment region featuring a point of contact between a tire of a vehicle and the roadway that are read in by at least one detection device and are able to be correlated with the coefficient of friction; and ascertaining the coefficient of friction using the processed sensor signals.

For example, this method can be implemented in software or hardware or in a mixed form of software and hardware, such as in a device or in a control unit. The coefficient of friction is able to be determined in the form of an estimated value and, additionally or alternatively, as a probability distribution of a friction at a particular location or region of the roadway. The coefficient of friction can also represent a value range, the coefficient of friction then representing an average value and a confidence interval or the like, for example. The coefficient of friction can be intended for use in an actuation of a vehicle function of a vehicle, in particular an assistance function or an assistance system of a vehicle. The status data can represent physical measuring values obtained by the at least one detection device. A detection device can be developed to detect the status data in the form of the sensor signals and to provide them in addition or as an alternative. The environment region can include a subsection of the roadway for which the coefficient of friction, with regard to contact between a tire of a vehicle and the roadway, is to be determined. The method can also include a step of reading in the sensor signals from an interface with the at least one detection device. It is also possible that the method includes a step of supplying the coefficient of friction, in the form of a control signal, for output to an interface with at least one vehicle.

According to an example embodiment, in the step of processing, sensor signals are able to be processed that represent status data read in from a data source on the Internet and, additionally or alternatively, status data that were obtained from processed sensor signals. The status data can represent a season, a time of day, weather information, a traffic volume, a road characteristic, a road-sanding priority by a road operator and, additionally or alternatively, a driving behavior of vehicles at the point of contact. Such an embodiment offers the advantage that all kinds of meaningful status data pertaining to an environment of a location of the frictional contact are able to be taken into account and used in order to allow for a reliable and precise determination of the coefficient of friction.

Also, in the step of processing, at least one parameter of the processing rule can be adjusted as a function of the status data. More specifically, the at least one parameter of the processing rule can be adjusted as a function of a type, property and, additionally or alternatively, an origin of the status data. Such an embodiment offers the advantage that the processing rule is adaptable to the type of sensor signals or detection devices so that data sources that are available in an application environment are able to be taken into account for a precise determination of the coefficient of friction.

Furthermore, in the step of ascertaining, the coefficient of friction is able to be checked for plausibility with the aid of the status data. In so doing, the coefficient of friction is able to be ascertained using processed sensor signals, which represent additional status data, e.g., driving data of a vehicle, environment data, infrastructure data and, additionally or alternatively, other status data. In the step of ascertaining, a coefficient of friction, provisionally ascertained with the aid of processed sensor data, is able to be checked for plausibility using the status data. Such an embodiment offers the advantage that the determination of the coefficient of friction is able to be carried out in an even more reliable and situationally correct manner.

In addition, in the step of processing, the environment region is able to be defined using a geographical position of a vehicle and, additionally or alternatively, using a position-related cluster analysis of status data. Such an embodiment offers the advantage of allowing for an identification of regions of interest for which a coefficient of friction is able to be determined in a simple and reliable manner.

Furthermore, in the step of processing, the sensor signals can be processed with the aid of a stochastic filter, a regression model and, additionally or alternatively, a recurrent neural network as the processing rule. In an advantageous manner, such an embodiment makes it possible to use already sufficiently known and established processing rules, without any additional outlay, and to adapt them to the respective application scenarios.

According to an example embodiment, a method for controlling a vehicle function of a vehicle includes: receiving a control signal, which was generated using a coefficient of friction that was determined according to an example method described above; and actuating the vehicle function using the received control signal.

This method, for example, can be implemented in the form of software or hardware or in a mixed form of software and hardware, such as in a device or in a control unit. The vehicle function can represent an assistance function of an assistance system of the vehicle. The vehicle can be a vehicle for highly automated driving.

According to an example embodiment, devices are configured to carry out, actuate, or implement the described methods, which makes possible to rapidly and efficiently achieve the objective on which the present invention is based.

For this purpose, the device can include at least one processing unit for processing signals or data, at least one memory unit for storing signals or data, at least one interface with a sensor or an actuator for reading in sensor signals from the sensor or for outputting data or control signals to the actuator, and/or at least one communications interface for reading in or outputting data, which are embedded in a communications protocol. For example, the processing unit can be a signal processor, a microcontroller or the like, and the memory unit can be a flash memory, an EEPROM, or a magnetic memory unit. The communications interface can be developed to read in or output data in a wireless and/or a line-bound manner, and a communications interface, which is able to read in or output line-bound data, is able to read in these data, e.g., electrically or optically, from a corresponding data-transmission line, or output the data onto a corresponding data-transmission line.

In this instance, a device can be understood as an electrical device that processes sensor signals and outputs control and/or data signals as a function thereof. The device can have an interface, which could be developed in the form of hardware and/or software. In the case of a hardware development, the interfaces can be part of what is called a system ASIC, for example, which encompasses a wide variety of functions of the device. However, it is also possible that the interfaces are discrete, integrated switching circuits or are at least partially made up of discrete components. In the case of a software development, the interfaces can be software modules, which are provided on a microcontroller in addition to other software modules, for instance.

According to an example embodiment of the present invention, a computer program product or a computer program having program code, which can be stored on a machine-readable carrier or memory medium such as a semiconductor memory, a hard-disk memory, or an optical memory is usable for carrying out, implementing, and/or actuating the steps of the method according to one of the afore-described example embodiments, in particular when the program code or the program is executed on a computer or on a device.

Exemplary embodiments of the introduced approach are illustrated in the drawings and described in greater detail in the following description.

### BRIEF DESCRIPTION OF THE DRAWINGS

FIG. 1 schematically illustrates of a networked system according to an example embodiment of the present invention.

FIG. 2 schematically illustrates parts of the system of FIG. 1, according to an example embodiment of the present invention.

FIG. 3 is a flowchart illustrating a determination method according to an example embodiment of the present invention.

FIG. 4 is a flowchart illustrating a controlling method according to an example embodiment of the present invention.

### DETAILED DESCRIPTION

Before exemplary embodiments are described in greater detail in the following text with reference to the figures, backgrounds and bases of exemplary embodiments will be discussed briefly at the outset. With the aid of what is referred to as connectivity units, for example, developments in the field of networked vehicles make it possible to exchange sensor data that pertain to the current roadway, speed, traffic situation, etc. By processing such data and due to a resulting yield of information relating to road sections, for example, it is possible to drive in a highly automated manner and to operate predictive driver-assistance systems with greater safety. The vehicle is especially able to receive information about an environment that the vehicle could not generate on its own using its own sensor system.

A coefficient of friction of a contact between the road or the roadway surface and the vehicle is also important in this context. As a rule, no dedicated coefficient of friction sensors are installed in passenger cars and the like. According to example embodiments, it is possible to determine or estimate a coefficient of friction for road sections, especially with the aid of server-side processing of data from a variety of sensor systems of many different vehicles, such as acceleration-sensor systems in combination with weather sensor systems and roadside sensor systems, e.g., slickness sensors. Such information with regard to the coefficient of friction can then be used for the further development of functions with the goal of increasing both safety and comfort. Road coefficients of friction, entered into a coefficient of friction map, for instance, can be used to set vehicle speeds, such as ahead of curves, in an automated manner. Dangerous situations or accidents due to straying from the road, especially under difficult road conditions such as wetness or snow, are able to be avoided in this way.

Measuring vehicles equipped with measuring technology for friction coefficients are in existence for a direct, active measurement of the coefficient of friction in special situations, e.g., for determining a coefficient of friction on an airfield. To be mentioned in this context, for example, are what are referred to as the surface friction tester and the so-called sideway-force coefficient routine investigation machine. Both are based on a force measurement. The surface friction tester is a vehicle trailer that has three wheels. The third wheel is decelerated until the physical limit range is reached, up to a standstill of the tire. With the aid of the brake force that is required or the brake torque required to achieve this, it is possible to determine the friction force, and with the aid of the known normal force, it is possible to determine the coefficient of friction. The sideway-force coefficient routine investigation machine determines the friction force via the side force of a fifth wheel, which is inclined by 20 degrees in relation to the driving direction. The coefficient of friction can be determined using the normal force again.

In the following description of advantageous exemplary embodiments of the present invention, identical or similar reference numerals are used for the elements that are shown in the various figures and have a similar effect, and a repeated description of these elements is omitted.

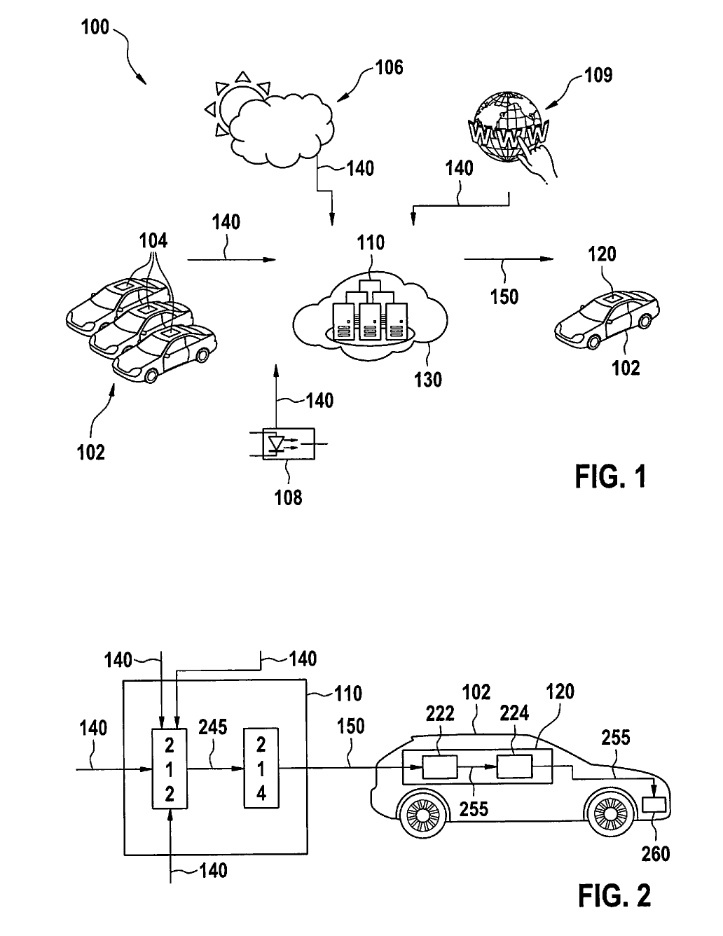

FIG. 1 shows a schematized illustration of a networked system 100 according to an exemplary embodiment. System 100 is developed to determine a coefficient of friction for road traffic and to make it usable. At a minimum, system 100 includes a first device 110 as well as a second device 120 for this purpose. Also part of system 100 and/or allocated thereto are, merely by way of example, four vehicles 102, vehicle sensors 104 in the form of driving-data sensors and/or vehicle-linked environmental sensors, such as only one environmental sensor 106 by way of example, only one infrastructure sensor 108 by way of example, at least one data source 109 on the Internet, as well as a server device 130, also referred to as a server backend 130, and a data cloud 130, also referred to as cloud 130. Networking that allows for a transmission of signals within system 100 is able to be realized via radio or some other type of data transmission, for example.

First device 110 is realized as part of server device 130. For illustration purposes and by way of example, second device 120 is disposed only in one of vehicles 102, which can be referred to as a receiver vehicle 102 in this case. Driving-data sensors 104 are exemplarily situated only in three of vehicles 102, which can be denoted as transmitter vehicles 102 in this case. Receiver vehicle 102, too, can also a vehicle sensor 104, and transmitter vehicles 102 can also have a second device 120 in each case.

First device 110 is developed to determine a coefficient of friction for a contact between a tire of a vehicle 102 and a roadway. First device 110 is developed to read in sensor signals 140 from vehicle sensors 104, environmental sensor 106, infrastructure sensor 108, and data source 109. Sensor signals 140 represent status data or physical measured values, e.g., environmental data from environmental sensor 106 for an environment region, infrastructure data from infrastructure sensor 108 for the environment region, and/or driving data and/or environment data of vehicles 102 from vehicle sensors 104. Furthermore, first device 110 is developed to determine the coefficient of friction using sensor signals 140, and to supply or output a control signal 150 that represents or includes the coefficient of friction. Second device 120 is developed to control a vehicle function of vehicle 102, in this instance, receiver vehicle 102, with the aid of control signal 150.

System 100 is set up in such a way that many vehicles 102 transmit sensor signals 140 or sensor-system data, e.g., via a mobile telephony network, to server backend 130 or to first device 110 realized therein. Added to this are infrastructure data, e.g., road-sensor system data, as well as environment data, such as weather data, which are able to be called up. According to an exemplary embodiment, using first device 110, sensor signals 140 are processed with the aid of a stochastic filter in time sequences, for example, in an effort to aggregate a location-dependent coefficient of friction. This aggregated coefficient of friction is able to be forwarded in the form of a control signal 150 to further vehicles 102 in a locally precise manner in order to thereby provide participating vehicles 102 with information about the current coefficient of friction in a respective region or a respective environment region.

FIG. 2 shows a schematized representation of parts of the system from FIG. 1. In the illustration of FIG. 2, only first device 110 and receiver vehicle 102 including second device 120 and a vehicle function 260 are shown from the system from FIG. 1 by way of example. Vehicle function 260, for example, involves an assistance function of an assistance system of receiver vehicle 102.

First device 110 has a processing device 212 and an ascertainment device 214. Processing device 212 is developed to process sensor signals 140 using a processing rule in order to generate processed sensor signals 245. Sensor signals 140 represent at least status data, which pertain to an environment region featuring a point of contact between a tire of a vehicle 102 and the roadway, that are read in by at least one detection device and are able to be correlated with the coefficient of friction. In this instance, the at least one detection device refers to the vehicle sensors, the environmental sensor, the infrastructure sensor, and/or data source 109 from FIG. 1. Ascertainment device 214 is developed to ascertain the coefficient of friction using processed sensor signals 254. First device 110 is developed to output the ascertained coefficient of friction in the form of control signal 150, or to make it available for output.

Second device 120 includes a receiver device 222 and an actuation device 224. Receiver device 222 is developed to receive control signal 150 from first device 110. In addition, receiver device 222 is developed to output or make available to actuation device 224 a received control signal 255. Actuation device 224 is developed to forward received control signal 255 to vehicle function 260 in order to actuate vehicle function 260 with the aid of received control signal 255.

As an alternative, vehicle function 260 can be directly actuated with the aid of control signal 150. For this purpose, first device 110 can be developed to supply or output a suitable actuation signal 150 for vehicle function 260. The second device can be omitted here.

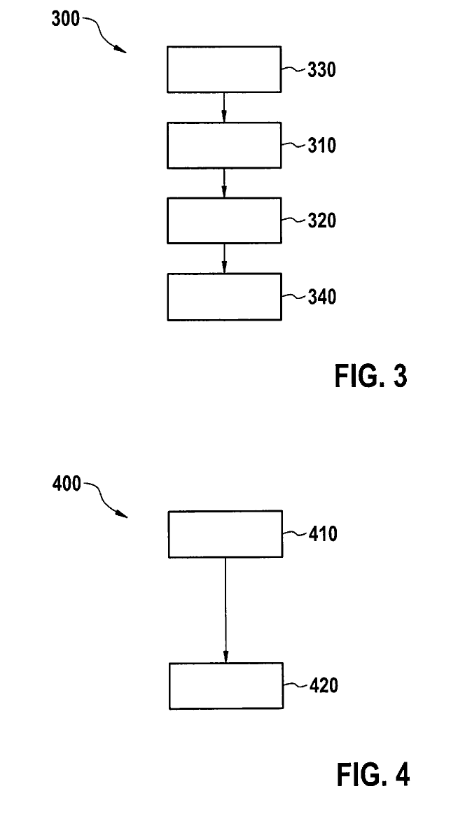

FIG. 3 is a flowchart of a method 300 for determining, according to an exemplary embodiment. Method 300 can be carried out in order to determine a coefficient of friction for a contact between a tire of a vehicle and a roadway. Method 300 for determining is able to be executed in connection with the system from FIG. 1 or FIG. 2. In addition, method 300 for determining can be executed using, or with the aid of, the first device from FIG. 1 or FIG. 2.

In method 300 for determining, sensor signals are processed in a step 310 of processing using a processing rule in order to generate processed sensor signals. The sensor signals represent at least status data, which pertain to an environment region featuring a point of contact between a tire of a vehicle and the roadway, which are read in by at least one detection device and are able to be correlated with the coefficient of friction. In the following text, the coefficient of friction is ascertained in a step 320 of ascertaining using the processed sensor signals.

According to an exemplary embodiment, in a step 310 of processing, sensor signals, which represent status data read in from a data source on the Internet and/or obtained from processed sensor signals, are processed. For example, the status data represent a season, a time of day, weather information, a traffic volume, a road characteristic, a road-sanding priority by a road operator, and/or a driving behavior of vehicles at the point of contact. According to an exemplary embodiment, in step 310 of processing, at least one parameter of the processing rule is adjusted as a function of the status data. Optionally, the environment region is defined in step 310 of processing with the aid of a geographical position of a vehicle and/or with the aid of a position-related cluster analysis of status data. According to an exemplary embodiment, in step 310 of processing, the sensor signals are processed using as a processing rule a suitable signal-processing method. According to an exemplary embodiment, in step 320 of ascertaining, the coefficient of friction is checked for plausibility on the basis of the status data.

According to an exemplary embodiment, method 300 for determining also includes a step 330 of reading in the sensor signals from an interface with the at least one detection device. As an option, method 300 for determining also has a step 340 of providing the coefficient of friction, in the form of a control signal, for output to an interface with at least one vehicle.

FIG. 4 is a flowchart of a method 400 for controlling, according to an exemplary embodiment. Method 400 is able to be executed in order to control a vehicle function of a vehicle. Method 400 for controlling can be carried out in connection with the system from FIG. 1 or FIG. 2. Method 400 for controlling can also be carried out with the aid of the second device from FIG. 1 or FIG. 2.

In method 400, a control signal is received in a step 410 of receiving, which is generated using a coefficient of friction determined by executing the method for determining from FIG. 3, or by executing a similar method. In a subsequent step 420 of actuating, the vehicle function is actuated using the control signal that was received in step 410 of receiving.

With reference to the afore-described figures, exemplary embodiments will be described and/or briefly introduced in different words in the following text, in summarized form.

Apart from the current framework conditions, which a sensor or a detection device 104, 106, 108, 109 is able to detect and/or provide, it is also possible according to exemplary embodiments to consider typical conditions for the location for which the coefficient of friction determination is performed when determining or estimating the coefficient of friction. These framework conditions in the form of sensor signals 140 or status data, for example, are provided and/or detected either by data source 109 on the Internet or determined by what is known as a machine-learning process on the basis of historical, compiled status data. The locations or environment regions can be defined by coordinates (width, length, height or latitude, longitude, altitude) on the one hand, or with the aid of a cluster analysis or clustering on the other hand.

Thus, for example, a probability distribution of the coefficient of friction is ascertained for the environment regions or specific locations as a function of the season, the time of day (absolutely or relative to the sunrise and/or sunset), typical weather conditions (temperature, humidity, sunshine hours, amount of precipitation, fog . . . ) traffic volume, the type of road or the road-sanding priority of the road operator, etc. According to an exemplary embodiment, a direct determination or estimation of the coefficient of friction is carried out in method 300 by determining probabilities, for instance as to whether at least one vehicle 102 in an environment region is equipped with summer tires, winter tires, all-weather tires, or with snow chains, taking the aforementioned conditions into account, and/or whether at least one vehicle 102 is driving faster or slower than a reference value, taking the aforementioned conditions into consideration.

In method 300, the status data with regard to the environment regions, represented by sensor signals 140, are used directly as input values and/or as parameters in the determination or estimation of the coefficient of friction, are used for parameterizing the processing rule, and/or are used for the plausibility check of the ascertained coefficients of friction. An improved statement with regard to the current coefficient of friction is therefore able to be made, in particular in regions that encounter little traffic.

If an exemplary embodiment includes an “and/or” linkage between a first feature and a second feature, then this should be read to indicate that the exemplary embodiment according to one specific embodiment includes both the first feature and the second feature, and according to a further specific embodiment, it includes either only the first feature or only the second feature.

What is claimed is:

1. A method comprising:
producing processed signals by processing sensor signals that represent status data (a) regarding an environment region in which there is a point of a contact between a tire of a vehicle and a roadway, (b) that are read in by at least one detection device, and (c) that are correlatable with a coefficient of friction of the contact; and
ascertaining the coefficient of friction based on the processed signals.

2. The method of claim 1, wherein the processed sensor signals include signals that represent status data that (a) are at least one of read in from a data source on the Internet and obtained from previously processed signals, and (b) represent at least one of a season, a time of day, weather information, a traffic volume, a road property, a street-sanding priority by a road operator, and a driving behavior of vehicles at the point of contact.

3. The method of claim 2, wherein parameter of a processing rule used for the processing is adjusted as a function of the status data.

4. The method of claim 2, further comprising using the status data to check a plausibility of the ascertained coefficient of friction.

5. The method of claim 2, further comprising defining the environment region using a position-related cluster analysis of status data.

6. The method of claim 1, further comprising defining the environment region based on a geographical position of the vehicle.

7. A method for controlling a vehicle function of a vehicle, the method comprising:
receiving a control signal generated based on a coefficient of friction of a contact between a tire of the vehicle and a roadway, wherein the coefficient of friction is determined based on a processed version of sensor signals that represent status data (a) regarding an environment region in which there is a point of the contact between the tire of the vehicle and the roadway, (b) that are read in by at least one detection device, and (c) that are correlatable with the coefficient of friction; and
actuating the vehicle function based on the received control signal.

8. A device comprising:
an interface to at least one sensor; and
a processor, wherein the processor is configured to:
produce processed signals by processing sensor signals received via the interface and that represent status data (a) regarding an environment region in which there is a point of a contact between a tire of a vehicle and a roadway, and (b) that are correlatable with a coefficient of friction of the contact; and
ascertain the coefficient of friction based on the processed signals.

9. The device of claim 8, wherein the processor is configured to:
generate a control signal based on the ascertained coefficient of friction; and
transmit the control signal to the vehicle to actuate a function of the vehicle.

10. A non-transitory computer-readable medium on which are stored instructions that are executable by a processor and that, when executed by the processor, cause the processor to perform a method, the method comprising:
producing processed signals by processing sensor signals that represent status data (a) regarding an environment region in which there is a point of a contact between a tire of a vehicle and a roadway, (b) that are read in by at least one detection device, and (c) that are correlatable with a coefficient of friction of the contact; and
ascertaining the coefficient of friction based on the processed signals.
